(19) United States
(12) Patent Application Publication
(10) Pub. No.: US 2008/0173148 A1
(43) Pub. Date: Jul. 24, 2008

(54) Worktable assembly for cutting machine

(76) Inventor: Yuehting Chen, Taichung County (TW)

Correspondence Address: Yuehting Chen, P.O. Box 44-2049, Taipei, 10668, omitted

(21) Appl. No.: 11/707,057

(22) Filed: Feb. 16, 2007

(30) Foreign Application Priority Data
Jan. 19, 2007 (TW) 096201051

(51) Int. Cl. B26D 7/06

(52) U.S. Cl. 83/412

(57) ABSTRACT

A worktable assembly for a cutting machine includes a worktable with two first rods connected to an underside thereof. A frame is located beneath the worktable and rested on a tank with water filled in the tank. Two second rods are connected to the frame and parallel to the first rods. A movable member has two first passages and two second passages, wherein the first rods movably extend through the two first passages and the two second rods movably extend through the two second passages.

### BACKGROUND OF THE INVENTION

(1) Field of the Invention

The present invention relates to a worktable for a cutting machine wherein the worktable can be moved longer distance so as to provide support for large workpieces.

(2) Description of the Prior Art

A conventional cutting machine 10 is shown in FIG. 1 and generally includes a worktable 11 which is supported on a frame 12 and the frame 12 is rested on a tank 13 in which water is filled. Two rods 15 are connected to the frame 12 and two pairs of sleeves 14 are movably mounted on the two rods 15, and the worktable 11 is connected to the sleeves 14. A cutting unit (not shown) is connected to the frame 12 so as to cut workpiece (not shown) on the worktable 11. The worktable 11 is movable along the two rods 15 when the workpiece is longer than the worktable 11 such that the workpiece can be supported by the worktable 11. However, the maximum distance that the worktable 11 can move is “h”, if the workpiece is longer than “h”, a portion of the workpiece might be deformed because of lack of support. Therefore, the user may need to cut the workpiece in different direction by changing the workpiece on the worktable 11 with limited support area.

The present invention intends to provide a worktable assembly for a cutting machine and the worktable can be moved along two different pairs of rods respectively and the two pairs of rods are located at different heights so that the worktable can be moved to a far distance.

### SUMMARY OF THE INVENTION

The present invention relates to a worktable assembly for a cutting machine and the worktable assembly comprises a worktable which is movably connected to two first rods. A frame is located beneath the worktable and rested on a tank in which water is filled. Two second rods are connected to the frame and parallel to the first rods. A movable member has two first passages and two second passages. The first rods movably extend through the two first passages and the two second rods movably extend through the two second passages.

The primary object of the present invention is to provide a worktable assembly for a cutting machine and the worktable can be moved a longer distance along two pairs of rods in one direction and two rods are extended from the worktable in another direction.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a side view of a conventional worktable assembly for a cutting machine;

FIG. 2 is an exploded view to show a worktable assembly for a cutting machine of the present invention;

FIG. 3 is a perspective view to show the cutting machine equipped with the worktable assembly of the present invention;

FIG. 4 is a side view to show the worktable assembly of the present invention;

FIGS. 5 and 6 show that the worktable assembly provides longer travel distance in two opposite directions;

FIG. 7 show another side view of the worktable assembly of the present invention, and

FIG. 8 shows two third rods are pulled from a side of the worktable.

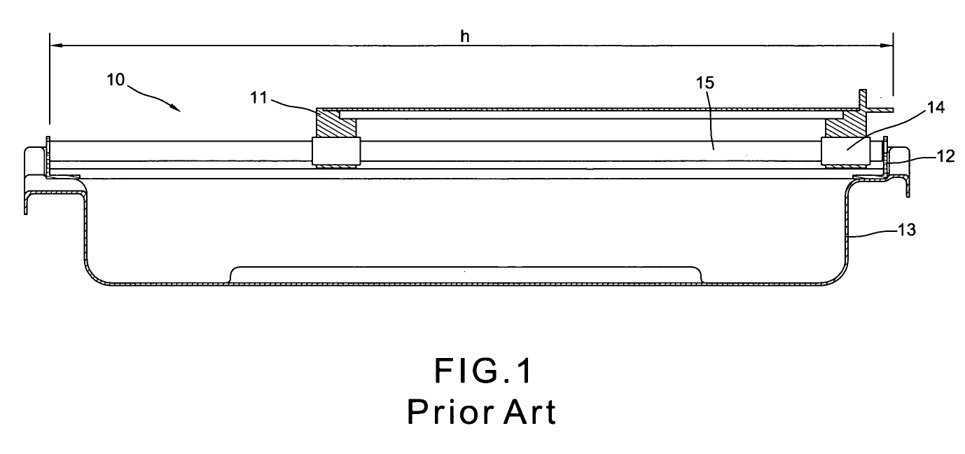

### DETAILED DESCRIPTION OF THE PREFERRED EMBODIMENTS

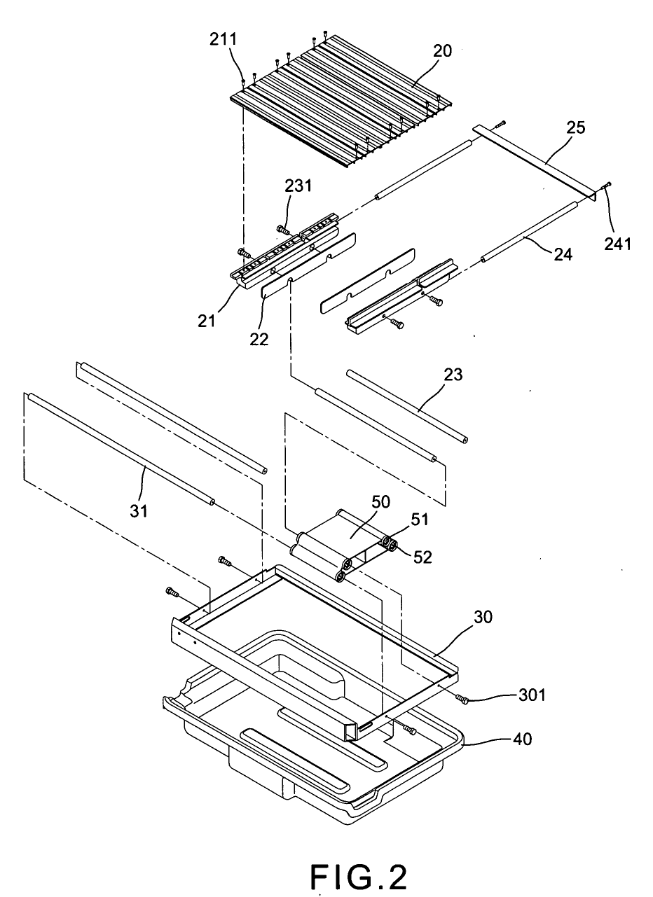

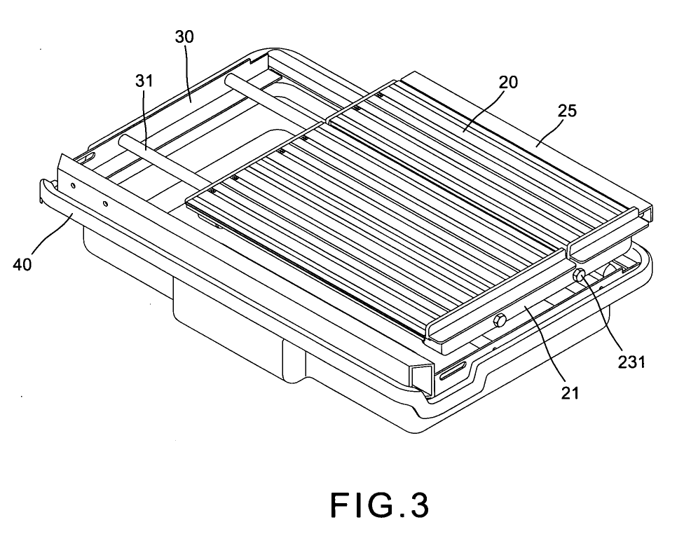

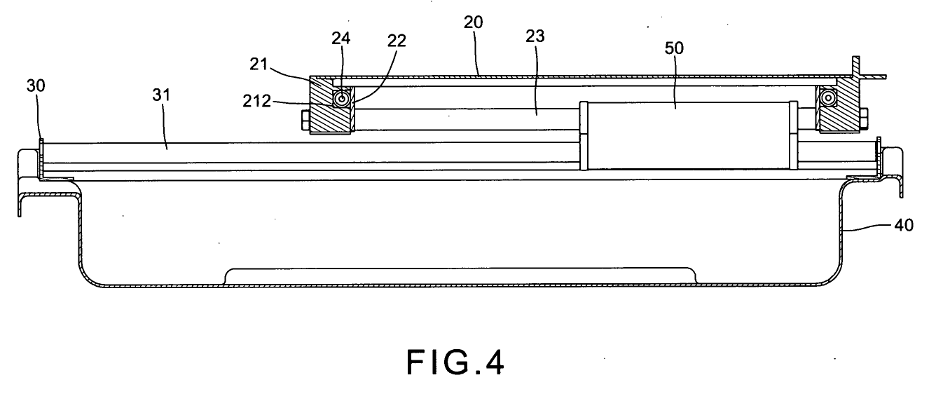

Referring to FIGS. 2 to 4, the worktable assembly for a cutting machine of the present invention comprises a worktable 20 and two positioning members 21 and two guide plates 22 are connected on two ends of the underside of the worktable 20 by screws 211. Two first rods 23 are perpendicularly connected between the two positioning members 21 and two guide plates 22 by screws 231.

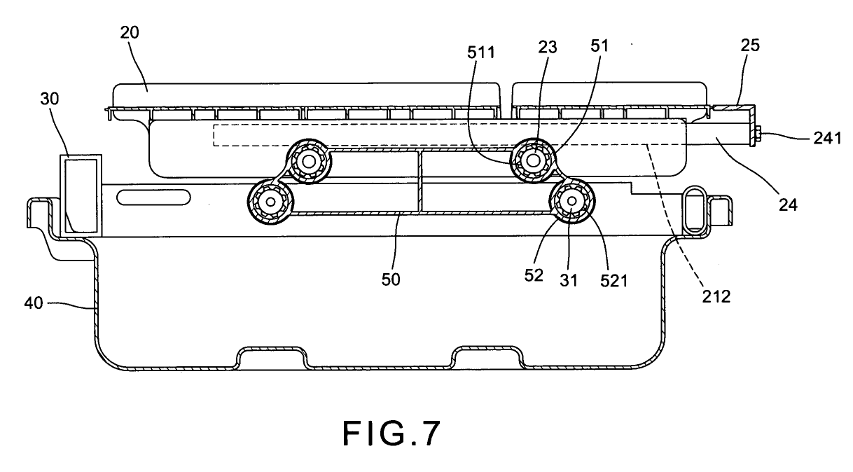

A frame 30 is located beneath the worktable 20 and rested on a tank 40 in which water is filled. Two second rods 31 are connected between two ends of the frame 30 by screws 301 and parallel to the first rods 23. A trapezoid movable member 50 has two first passages 51 and two second passages 52, wherein the two first passages 51 are located higher than the second passages 52 in the movable member 50. Each of the first passages 51 and the second passages 52 includes a toothed inner periphery 511/521 as shown in FIG. 7. The first rods 23 movably extend through the two first passages 51 and the two second rods 31 movably extend through the two second passages 52.

Each of the two positioning members 21 has an axial passage 212 and two third rods 24 movably extend through the two axial passages 212. A handle 25 is connected between the two third rods 24 by screws 241. It is noted that the two third rods 24 are perpendicular to the first and second rods 23, 31.

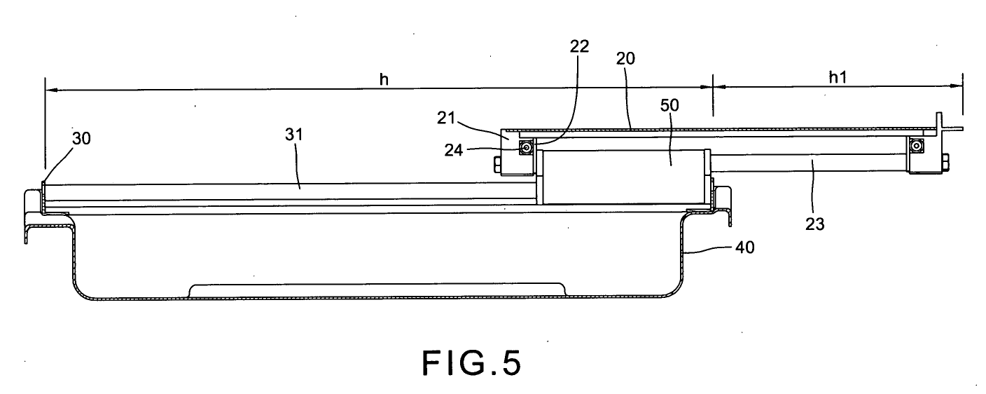

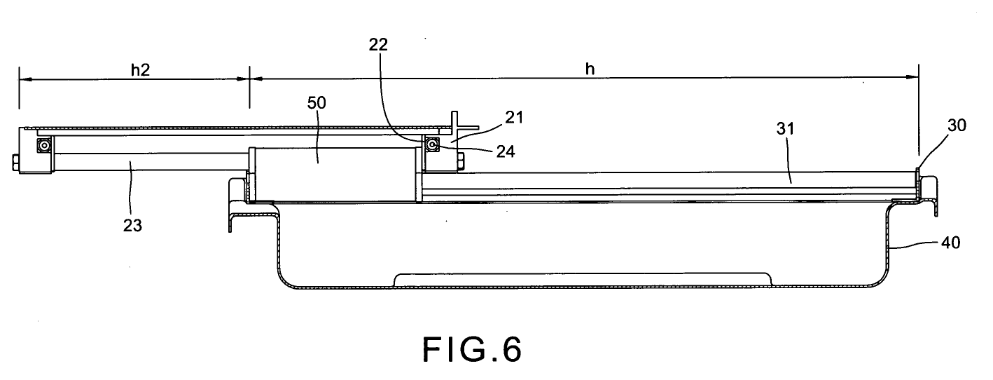

As shown in FIGS. 5 and 6, the worktable 20 can be moved to right or left along the second rods 31 by a distance “h”, and the worktable 20 can be further moved in the same direction along the second rods 23 by a distance “h1”. Therefore, the worktable 20 can be moved a distance “h+h1” which is longer than the travel distance of conventional worktable assembly. By this specific structure, a long workpiece (not shown) can be well supported by the worktable 20.

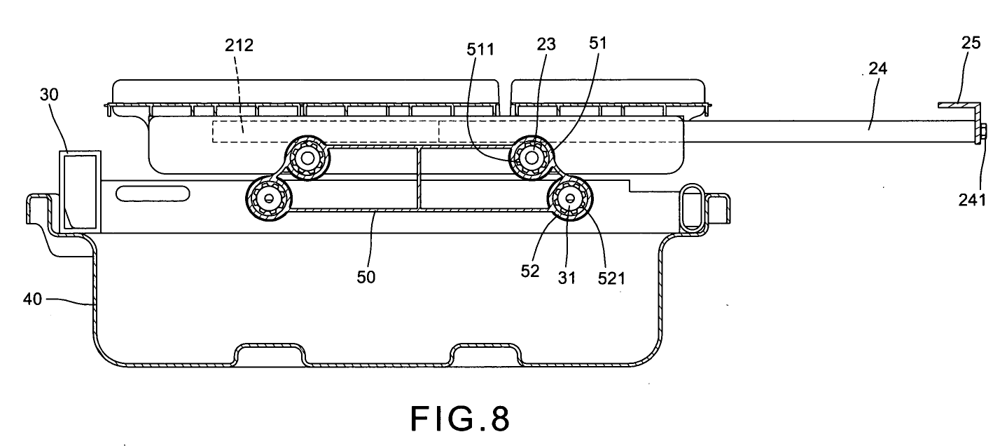

As shown in FIGS. 7 and 8, the user may pull the handle 25 to pull the two third rods 24 from a side of the worktable 20 and this increase the width for supporting the workpiece when needed.

While we have shown and described the embodiment in accordance with the present invention, it should be clear to those skilled in the art that further embodiments may be made without departing from the scope of the present invention.

What is claimed is:

1. A worktable assembly for a cutting machine, comprising:
a worktable;
two first rods connected to an underside of the worktable;
a frame located beneath the worktable and being rested on a tank, two second rods connected to the frame and being parallel to the first rods, and
a movable member having two first passages and two second passages, the first rods movably extending through the two first passages and the two second rods movably extending through the two second passages.

2. The worktable assembly as claimed in claim 1, wherein the two first passages are located higher than the second passages in the movable member.

3. The worktable assembly as claimed in claim 1, wherein each of the first passages and the second passages includes a toothed inner periphery.

4. The worktable assembly as claimed in claim 1, wherein two positioning members and two guide plates are connected on two ends of the underside of the worktable, the two first rods are perpendicularly connected between the two positioning members and two guide plates.

5. The worktable assembly as claimed in claim 4, wherein each of the two positioning members has an axial passage and two third rods movably extend through the two axial passages.

6. The worktable assembly as claimed in claim 5, wherein a handle is connected between the two third rods.
